(19) United States
(12) Patent Application Publication
(10) Pub. No.: US 2002/0067435 A1
(43) Pub. Date: Jun. 6, 2002

(54) DIGITAL YUV VIDEO EQUALIZATION GAMMA AND CORRECTION

(76) Inventor: MARK RAPAICH, WESTFIELD, IA (US)

Correspondence Address: SCHWEGMAN LUNDBERG WOESSNER, & KLUTH, PO BOX 2938, MINNEAPOLIS, MN, 55402

(21) Appl. No.: 09/217,873

(22) Filed: Dec. 21, 1998

(51) Int. Cl. H04N 5/21; H04N 5/202

(52) U.S. Cl. 348/674; 348/625

(57) ABSTRACT

Gamma correction, color saturation, tint, brightness, and contrast correction are provided for digital YUV signals by use of video hardware or software in a personal computer. The video hardware receives a digital YUV signal from a source such as a DVD player. An algorithm is empirically determined for the type of display device used to display the signal. A least-squares fit polynomial equation or a lookup table is used to determine a correction for displayed intensity by applying one or more corrections such as gamma correction, color saturation, tint, brightness, or contrast correction. The resulting image is displayed with the proper gamma for both video source and display.

### FIELD OF THE INVENTION

The present invention relates to video equalization and gamma correction in computer systems and in particular to video equalization and gamma correction of digital YUV video signals.

### BACKGROUND

Cathode ray tubes, CRTs, are made with electron guns which emit electrons that are guided by electromagnetic fields to provide a picture on a screen. It has been long known that CRTs do not produce a light intensity proportional to the input voltage controlling the strength of the electron gun emissions. Instead, the intensity produced by a CRT is proportional to the input voltage raised by a power of a value referred to as gamma. The value of gamma varies depending on the CRT, but is typically close to 2.5. Projecting an image that is not distorted in contrast therefore requires correcting the intensity voltage provided to the electron guns of the CRT by a power of gamma.

Most sensors used in television cameras produce output voltages proportional to image intensity. A correction for CRT gamma must be applied to the camera signal at some point before the image is displayed on a CRT. Television standards include an initial gamma correction of 0.45 applied in the television camera, to compensate for both the CRT gamma of 2.5 and the apparent reduction in contrast when a TV is viewed against the dim background typically found in a living room.

Many computer displays ignore the effects of CRT monitor or display gamma. Digital video information is converted linearly into voltages that drive the CRT in the display. The digital image intensity values in the frame buffer are therefore not proportional to the resulting display intensity. For example, a digital value of one half the maximum in the frame buffer will result in a displayed intensity less than one half maximum display intensity.

Some displays include hardware lookup tables that correct for monitor gamma. In these systems, digital RGB frame buffer values provided by the system are corrected for gamma by the CRT by means of a lookup table in the display controller, producing a display system gamma of 1.0 that linearly maps frame buffer values into displayed intensity. In U.S. Pat. No. 5,589,889 to Kawaoka, gamma lookup tables are set by means of a processor for both a desired video source and for a desired display device.

While gamma correction is widely provided for video information within personal computers in the digital RGB color space, it is not currently provided for digital information in the YUV color space. RGB encoded digital video consists of three digital values, each value representing an intensity level for red, green, or blue color. Application of gamma to such a signal involves simple mathematical alteration of these intensity signals to produce corresponding corrected intensity signals.

Digital video in the YUV color space involves encoding of luminance (Y) and chrominance (UV) information in digital form. The UV component represents a point on a two-dimensional color space, such that differences in UV values are proportional to perceived color differences. Application of gamma correction to such a signal involves either conversion to the RGB color space before gamma correction or application of more complex mathematical algorithms than are needed in the RGB color space. Gamma correction of YUV signals is therefore computationally much more demanding if corrected in the YUV color space, so digital gamma correction of digital YUV signals is typically done after conversion to the RGB color space. There is a need to apply gamma correction to digital YUV signals in personal or general purpose computers without converting the signal to digital RGB as a necessary step in performing the gamma correction.

### SUMMARY

Gamma correction, color saturation, tint, brightness, and contrast correction are provided for digital YUV signals. Such correction is performed via application of algorithms to a digital YUV video stream.

In one embodiment, a processor applies an algorithm to the digital YUV signal and is incorporated into video hardware in a personal computer. The video hardware receives a digital YUV signal from a source such as a DVD player. The algorithm is empirically determined in one embodiment for the type of display device used to display the signal. The algorithm comprises a least-squares fit polynomial equation or a lookup table. The video hardware then corrects the displayed intensity by applying one or more corrections such as gamma correction, color saturation, tint, brightness, or contrast correction.

In a further embodiment, gamma, color saturation, tint, brightness, and contrast correction may be digitally controlled by software that allows a user to set the correction factors such as the gamma correction factor. The video hardware then applies this user-specified correction factor to the video signal through digital processing.

In another embodiment, the video hardware may receive video encoded with a gamma correction factor. The gamma correction factor is then compensated for by applying gamma correction needed for other video components such as a CRT, and result in a displayed image that is displayed with the proper gamma for both the video source and display.

### DESCRIPTION OF THE FIGURES

FIG. 1 is a block diagram of a typical computer system in accordance with the present invention.

FIG. 2 is a diagram illustrating the display intensity produced by different electron gun voltages in a typical CRT, both with and without gamma correction.

FIG. 3 is a block diagram showing incorporation of a digital processor that may be used to correct digital YUV signals for gamma, color saturation, tint, brightness and contrast.

### DETAILED DESCRIPTION

In the following description, reference is made to the accompanying drawings, which form a part of this description and show by way of illustration specific embodiments in which the invention may be practiced. These embodiments are described in sufficient detail to enable those skilled in the art to practice the invention. Other embodiments may also be utilized to practice the invention, and structural, logical, and electrical changes may be made without departing from the scope of the present invention. The following description is, therefore, not to be taken in a limiting sense, and the scope of the present invention is defined by the appended claims.

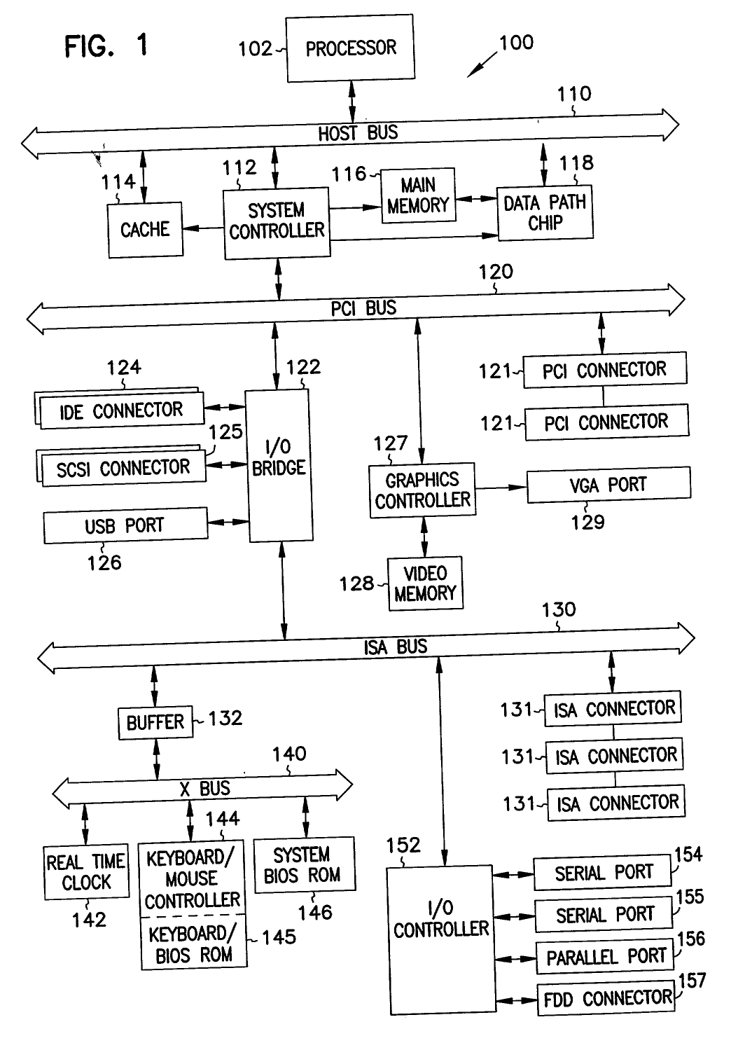

FIG. 1 shows a block diagram of a computer system 100 according to the present invention. In this embodiment, processor 102, system controller 112, cache 114, and data-path chip 118 are each coupled to host bus 110. Processor 102 is a microprocessor such as a 486-type chip, a Pentium®, Pentium II® or other suitable microprocessor. Cache 114 provides high-speed local-memory data (in one embodiment, for example, 512 kB of data) for processor 102, and is controlled by system controller 112, which loads cache 114 with data that is expected to be used soon after the data is placed in cache 112 (i.e., in the near future). Main memory 116 is coupled between system controller 114 and data-path chip 118, and in one embodiment, provides random-access memory of between 16 MB and 128 MB of data. In one embodiment, main memory 116 is provided on SIMMs (Single In-line Memory Modules), while in another embodiment, main memory 116 is provided on DIMMs (Dual In-line Memory Modules), each of which plugs into suitable sockets provided on a motherboard holding many of the other components shown in FIG. 1. Main memory 116 includes standard DRAM (Dynamic Random-Access Memory), EDO (Extended Data Out) DRAM, SDRAM (Synchronous DRAM), or other suitable memory technology. System controller 112 controls PCI (Peripheral Component Interconnect) bus 120, a local bus for system 100 that provides a high-speed data path between processor 102 and various peripheral devices, such as graphics devices, storage drives, network cabling, etc. Data-path chip 118 is also controlled by system controller 112 to assist in routing data between main memory 116, host bus 110, and PCI bus 120.

In one embodiment, PCI bus 120 provides a 32-bit-wide data path that runs at 33 MHZ. In another embodiment, PCI bus 120 provides a 64-bit-wide data path that runs at 33 MHZ. In yet other embodiments, PCI bus 120 provides 32-bit-wide or 64-bit-wide data paths that runs at higher speeds. In one embodiment, PCI bus 120 provides connectivity to I/O bridge 122, graphics controller 127, and one or more PCI connectors 121 (i.e., sockets into which a card edge may be inserted), each of which accepts a standard PCI card. In one embodiment, I/O bridge 122 and graphics controller 127 are each integrated on the motherboard along with system controller 112, in order to avoid a board-connector-board signal-crossing interface and thus provide better speed and reliability. In the embodiment shown, graphics controller 127 is coupled to a video memory 128 (that includes memory such as DRAM, EDO DRAM, SDRAM, or VRAM (Video Random-Access Memory)), and drives VGA (Video Graphics Adaptor) port 129. VGA port 129 can connect to industry-standard monitors such as VGA-type, SVGA (Super VGA)-type, XGA-type (eXtended Graphics Adaptor) or SXGA-type (Super XGA) display devices. Other input/output (I/O) cards having a PCI interface can be plugged into PCI connectors 121.

In one embodiment, I/O bridge 122 is a chip that provides connection and control to one or more independent IDE connectors 124-125, to a USB (Universal Serial Bus) port 126, and to ISA (Industry Standard Architecture) bus 130. In this embodiment, IDE connector 124 provides connectivity for up to two standard IDE-type devices such as hard disk drives, CDROM (Compact Disk-Read-Only Memory) drives, DVD (Digital Video Disk) drives, or TBU (Tape-Backup Unit) devices. In one similar embodiment, two IDE connectors 124 are provided, and each provide the EIDE (Enhanced IDE) architecture. In the embodiment shown, SCSI (Small Computer System Interface) connector 125 provides connectivity for up to seven or fifteen SCSI-type devices (depending on the version of SCSI supported by the embodiment). In one embodiment, I/O bridge 122 provides ISA bus 130 having one or more ISA connectors 131 (in one embodiment, three connectors are provided). In one embodiment, ISA bus 130 is coupled to I/O controller 152, which in turn provides connections to two serial ports 154 and 155, parallel port 156, and FDD (Floppy-Disk Drive) connector 157. In one embodiment, ISA bus 130 is connected to buffer 132, which is connected to X bus 140, which provides connections to real-time clock 142, keyboard/mouse controller 144 and keyboard BIOS ROM (Basic Input/Output System Read-Only Memory) 145, and to system BIOS ROM 146.

FIG. 1 shows one exemplary embodiment of the present invention, however other bus structures and memory arrangements are specifically contemplated.

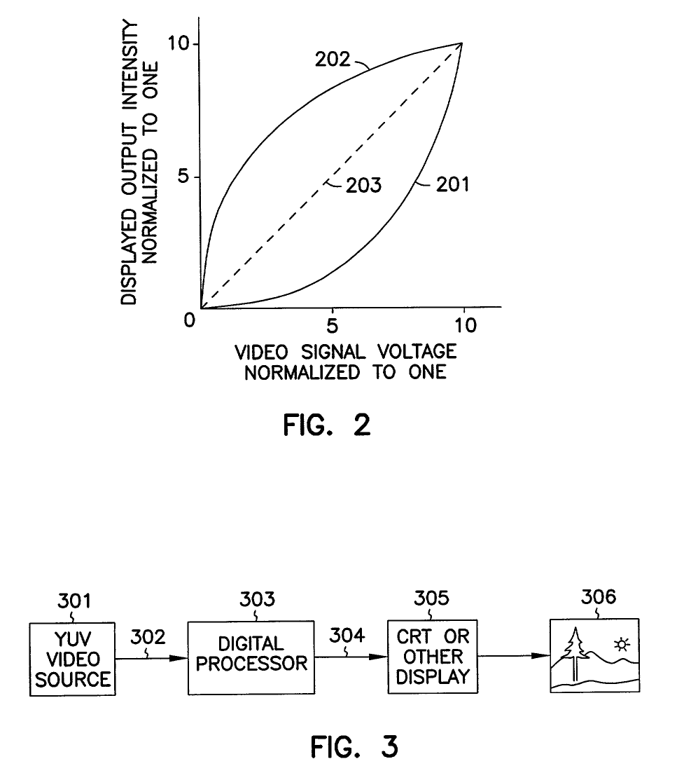

A diagram representing the nonlinearity between voltage input and display intensity in CRTs is shown in FIG. 2. A straight line 203 represents a curve wherein an incremental increase in video signal voltage creates a proportional increase in displayed output intensity. This curve represents the ideal video display system response, but is not characteristic of typical CRTs. A curve 201 illustrates that for relatively small voltage inputs, a typical CRT does not produce a proportional increase in displayed image intensity, but instead remains somewhat darker. Most CRTs have a gamma of about 2.5, requiring input voltage compensation by raising the input voltage to the power gamma to transform the uncorrected CRT response curve 201 into a perceived linear eye response curve also represented by curve 203. The factor by which the uncorrected CRT response curve 201 must be altered is displayed in the gamma compensation curve 202. This gamma compensation curve represents the response characteristics needed by a gamma correction circuit, such that small values of video signal input voltage provided to the gamma correction circuit result in an output that is proportionately larger than the input voltage.

FIG. 3 shows a portion of a computer system comprising the components of a digital YUV signal equalization apparatus. A digital YUV video signal 302 is provided by a digital YUV video source 301, and received by a digital processor 303. In one embodiment, the processor may be a commercially available digital signal processor programmed with mathematical algorithms to correct video distortions in the YUV video signal. In a further embodiment, the mathematical algorithm comprises an empirically determined least squares fit polynomial equation, determined for each display device. The algorithm comprises a lookup table having gamma values similarly determined at each of a plurality of signal levels dependent upon display device characteristics.

In another embodiment, the processor 303 corrects one or more digital YUV signal distortions selected from the group consisting of gamma correction, color saturation, tint, brightness and contrast. The processor outputs a corrected signal 304, that may be provided to a CRT or other display 305. The corrected signal 304 may be corrected for gamma, or equalized for color saturation, tint, brightness, or contrast, or any combination thereof. The display 305 then produces an image 306, corrected for the gamma properties of display 305 or other signal distortions.

The video source 301 may consist of any video source that produces a digital YUV signal, such as DVD, MPEG, CVD, CD, satellite broadcast, and NTSC digital video signals. In the preferred embodiment, the corrective algorithms processor 303 applies to the digital YUV signal 302 are implemented by software running on the personal computer or by a combination of software and hardware, so that a user may specify parameters of the algorithms and therefore control the degree of correction performed by the processor.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A personal computer system comprising:
a video source capable of providing a digital YUV video signal;
a video output capable of connecting to a video display device;
a digital processor employing a corrective algorithm that corrects the digital YUV signal provided by the video source and provides a corrected signal to the video output.

2. The personal computer of claim 1 where the correction is selected from the group consisting of gamma correction, color saturation correction, tint correction, brightness correction and contrast correction.

3. The personal computer system of claim 1, further comprising a software module for user configuration of the digital processor that corrects the digital YUV signal.

4. The personal computer system of claim 1, wherein the video sources comprise multiple sources selected from the group consisting of MPEG, NTSC, CVD, CD and satellite broadcast digital video signals.

5. The personal computer system of claim 2, wherein the digital YUV video signal is encoded with a correction factor that is compensated for in applying the corrective algorithms to the digital YUV signal.

6. A process comprising the steps of:
receiving a YUV digital video signal;
correcting the digital YUV signal within a personal computer; and
providing a corrected digital YUV signal to an output for connection to a display device.

7. The process of claim 6 where the correction is selected from the group consisting of gamma correction, color saturation correction, tint correction, brightness correction and contrast correction.

8. The process of claim 6, further comprising a step of configuration of a software module that configures the digital signal processor that corrects the digital YUV signal.

9. The process of claim 6, wherein the received YUV digital video signal is provided by video sources selected from the group consisting of MPEG, NTSC, CVD, CD and satellite broadcast digital video signals.

10. The process of claim 6, wherein the received digital YUV video signal is encoded with a correction factor that is compensated for in correcting the digital YUV signal.

11. A personal computer system comprising:
a processor;
a bus;
main memory;
a system controller;
a graphics controller;
a video source capable of providing a digital YUV video signal;
a video output capable of connecting to a video display device; and
a digital processor that corrects the digital YUV signal provided by the video source and provides a corrected signal to the video output.
